(19) United States
(12) Patent Application Publication
(10) Pub. No.: US 2016/0180670 A1
(43) Pub. Date: Jun. 23, 2016

(54) SYSTEM AND METHOD OF DETECTING ITEMS IDENTIFIED BY RADIO FREQUENCY IDENTIFICATION (RFID) TAGS IN A SMART SHOPPING CART

(71) Applicant: SYMBOL TECHNOLOGIES, INC., LINCOLNSHIRE, IL (US)

(72) Inventor: CHARLES B. SWOPE, CORAL SPRINGS, FL (US)

(21) Appl. No.: 14/574,991

(22) Filed: Dec. 18, 2014

(51) Int. Cl. G08B 13/24

(52) U.S. Cl. CPC G08B 13/246

(57) ABSTRACT

A smart shopping cart includes a basket having an open top, a plurality of electrically conductive side walls, and an electrically conductive bottom wall. Unidirectional, near-field, side antenna elements are mounted on, and electrically grounded to, the side walls. Each side antenna element radiates an electromagnetic field in an inward direction toward an interior of the basket. A near-field, bottom antenna element is mounted on, and electrically grounded to, the bottom wall, and radiates an electromagnetic field in an upward direction toward the interior of the basket. A cart controller excites all the antenna elements to create a composite, resonant electromagnetic field substantially within the basket with substantially no electromagnetic field leakage exteriorly past the side walls, and detects entry and exit of RFID-tagged items through the open top of the basket into and out of the resonant electromagnetic field.

### BACKGROUND OF THE INVENTION

The present disclosure relates generally to a system for, and a method of, detecting items identified by radio frequency identification (RFID) tags in a shopping cart, particularly a smart cart equipped with distributed antenna elements that create a resonant electromagnetic field substantially within a basket of the cart.

Radio frequency (RF) identification (RFID) tags have been proposed as a substitute for, or as a supplement to, using barcode symbols, such as Universal Product Code (UPC) symbols, in supply chain management, particularly in retail environments such as supermarket checkout systems, because, among other things, reading such barcode symbols requires a direct, optical line-of-sight to an electro-optical reader; such barcode symbols must be read one at a time; and poor printing or damage to even a small part of each such barcode symbol can sometimes prevent a successful reading. An RFID system typically includes an RFID reader for interrogating RFID tags attached to, or associated with, individual items. Each RFID tag senses an interrogating RF signal, and responds with a return RF signal that contains information stored internally in the RFID tag. The return RF signal is decoded into data by the RFID system, which thereby identifies, counts, or otherwise interacts with the associated item. The decoded data, also known as a payload, can denote a serial number, a price, a date, a destination, other attribute(s), or any combination of attributes, and so on. In contrast to reading barcode symbols, the RFID system does not require a direct line-of-sight to the RFID reader, and is capable of multi-directional reading of multiple RFID tags on multiple items at the same time. Thus, in one advantageous application, an overhead RFID reader can simultaneously interrogate and read all the RFID-tagged items present in a shopping cart at once in an effort to expedite the checkout process.

Yet, as advantageous as the known RFID systems have been, they have not proven altogether reliable in reading all the RFID-tagged items present in a shopping cart at checkout, and in providing an accurate accounting of all the cart's contents. During shopping, items can be added to, or withdrawn from, the cart, or may even be transferred to another cart without being returned to a store's shelves. Due to the large interior volume of some carts, one or more items might not be readily detected, especially if more than one of the same item is placed in the cart. In an effort to more accurately account for the cart's contents, the art has proposed adding an RFID reader directly to the cart. However, experience has shown that when a cart is pushed too close to RFID-tagged items that are still on the store's shelves, then the cart-mounted RFID reader might then inaccurately detect those unwanted items that are still on the store's shelves.

Accordingly, there is a need to more accurately and reliably read all the RFID-tagged items present in a shopping cart at checkout, and to provide an accurate accounting of all the cart's contents.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a perspective view of a smart shopping cart for use in a system for, and a method of, detecting RFID-tagged items in accordance with the present disclosure.

FIG. 2 is a schematic top plan view of some of the electromagnetic fields generated inside a basket of the cart of FIG. 1.

FIG. 3 is an electric schematic of electrical components mounted in the smart shopping cart of FIG. 1.

FIG. 4 is a top plan view of one of the side antenna elements mounted on a side wall of the smart shopping cart of FIG. 1.

FIG. 5 is a sectional view of the side antenna element of FIG. 4.

FIG. 6 is a perspective view of a bottom antenna element mounted on a bottom wall of the smart shopping cart of FIG. 1.

FIG. 7 is an enlarged perspective view of how the side antenna element of FIG. 4 is mounted on the side wall.

Skilled artisans will appreciate that elements in the figures are illustrated for simplicity and clarity and have not necessarily been drawn to scale. For example, the dimensions and locations of some of the elements in the figures may be exaggerated relative to other elements to help to improve understanding of embodiments of the present invention.

The system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

The present disclosure relates to a system for detecting items identified by radio frequency identification (RFID) tags. The system includes a shopping cart having a basket with an open top, and with a plurality of electrically conductive side walls and an electrically conductive bottom wall. Preferably, each side wall and the bottom wall are comprised of a grid of electrically conductive, spaced-apart rods that cross each other. A plurality of unidirectional, near-field, side antenna elements is mounted on, and electrically grounded to, the side walls. Each side antenna element is operative for radiating an electromagnetic field in an inward direction toward an interior of the basket. A near-field, bottom antenna element is mounted on, and electrically grounded to, the bottom wall, and radiates an electromagnetic field in an upward direction toward the interior of the basket. A cart controller is supported by the cart, for exciting, either simultaneously or sequentially, all the antenna elements to create a composite, resonant electromagnetic field substantially within the basket with substantially no electromagnetic field leakage exteriorly past the side walls, and for detecting entry and exit of each RFID-tagged item through the open top of the basket into and out of the resonant electromagnetic field. Preferably, each side antenna element has a ground plane that is electrically grounded to a respective side wall to contain the resonant electromagnetic field substantially within the basket. Advantageously, an indicator indicates the entry and exit of each RFID-tagged item through the open top of the basket. Thus, all the RFID-tagged items present in a shopping cart are accurately and reliably read, with an accurate accounting of all the cart's contents. Since there is substantially no electromagnetic field leakage exteriorly past the side walls of the cart's basket, RFID-tagged items that are still on the store's shelves in the vicinity of the cart during shopping will not be read.

In a preferred embodiment, the cart includes a mobile chassis for supporting the basket above a lower shelf, and the bottom antenna element is bidirectional and also radiates an electromagnetic field in a downward direction toward the lower shelf. The cart controller also detects placement and removal of each RFID-tagged item on and from the lower shelf

A method, in accordance with another aspect of the present disclosure, of detecting items identified by radio frequency identification (RFID) tags, is performed by configuring a shopping cart with a basket having an open top, and with a plurality of electrically conductive side walls and an electrically conductive bottom wall; mounting a plurality of unidirectional, near-field, side antenna elements on, and electrically grounding the side antenna elements to, the side walls; and mounting a near-field, bottom antenna element on, and electrically grounding the bottom antenna element to, the bottom wall. The method is further performed by exciting each side antenna element to radiate an electromagnetic field in an inward direction toward an interior of the basket, and by exciting the bottom antenna element to radiate an electromagnetic field in an upward direction toward the interior of the basket. The exciting of all the antenna elements is performed, either simultaneously or sequentially, to create a composite, resonant electromagnetic field substantially within the basket with substantially no electromagnetic field leakage exteriorly past the side walls. Entry and exit of each RFID-tagged item through the open top of the basket into and out of the resonant electromagnetic field is thereby detected.

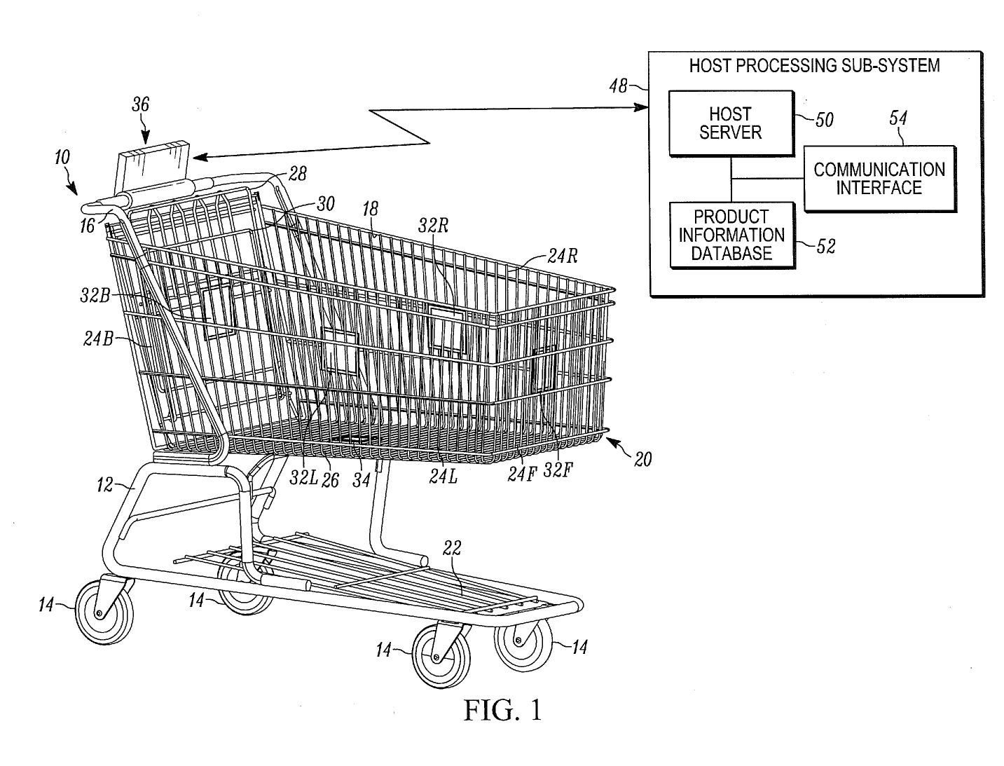

Turning now to the drawings, reference numeral 10 in FIG. 1 generally identifies a shopping cart including a mobile chassis 12 having a set of wheels 14, a handle 16, and a basket 20 having an open top 18, and a lower shelf 22 mounted below the basket 20. The basket 20 has an electrically conductive right side wall 24R, an electrically conductive left side wall 24L opposite to the right side wall 24R, an electrically conductive front side wall 24F extending between the right and left side walls 24R, 24L at a front of the cart, and an electrically conductive back side wall 24B extending between the right and left side walls 24R, 24L at a back of the cart. The basket 20 also has an electrically conductive bottom wall 26. Each side wall and the bottom wall are comprised of a grid of electrically conductive, spaced-apart rods or wires that cross each other. Each rod or wire may be constituted of a solid metallic material, or may have a plastic core overlain with an electrically conductive, metallic paint or layer. As illustrated, an electrically conductive partition wall 28 is pivotably mounted on the cart 10 for movement between a first position closely overlying the back side wall 24B and a second position spaced from the back side wall 24B to thereby form a seat 30 within the basket 20. In either position, the partition wall 28 is also considered herein as another back side wall at the back of the cart.

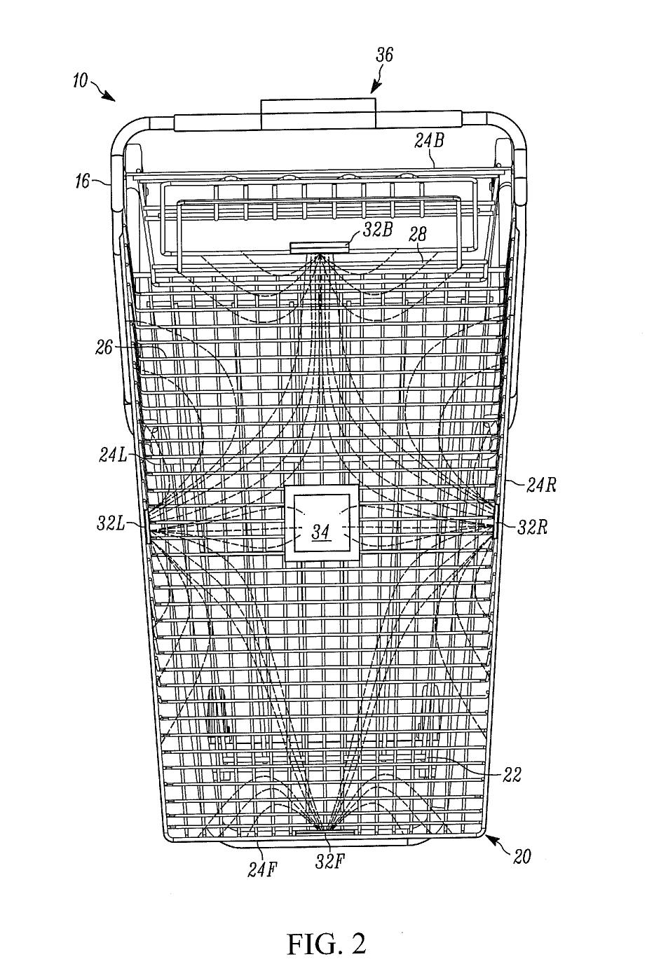

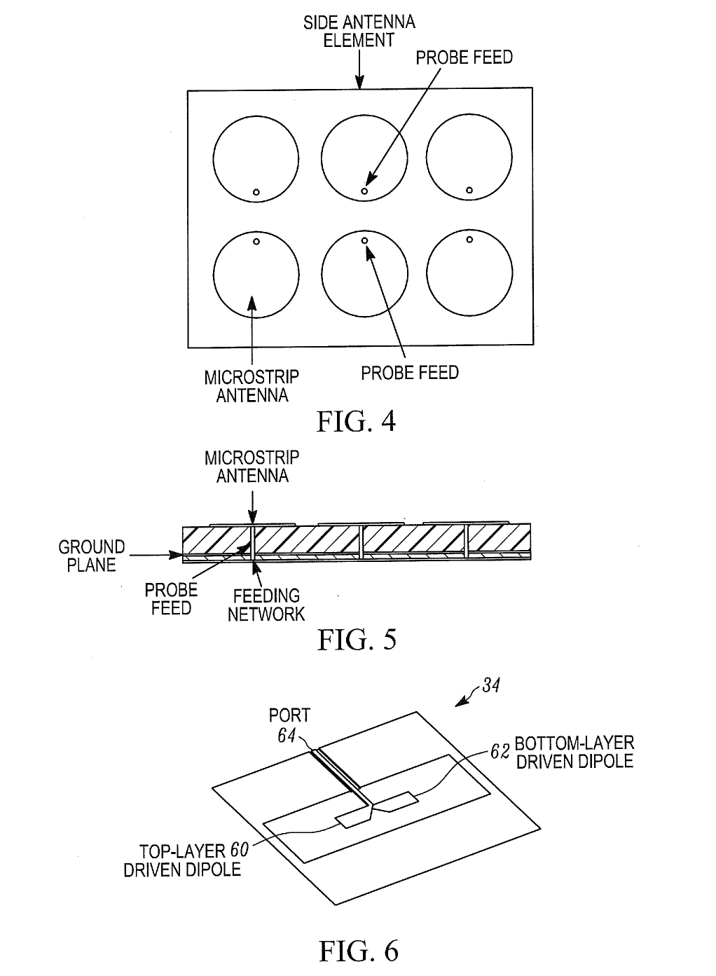

As shown in FIGS. 1-2, a unidirectional, near-field, right side antenna element 32R, a unidirectional, near-field, left side antenna element 32L, a unidirectional, near-field, front side antenna element 32F, and a unidirectional, near-field, back side antenna element 32B are mounted on, and each has a ground plane electrically grounded to, the right, left, front, and back, side walls 24R, 24L, 24F, and 24B or 28, respectively. As shown in FIG. 2, each side antenna element 32R, 32L, 32F, and 32B is operative for radiating an electromagnetic field in an inward direction toward an interior or center of the basket 20. Details of each side antenna element are described below in connection with FIGS. 4-5.

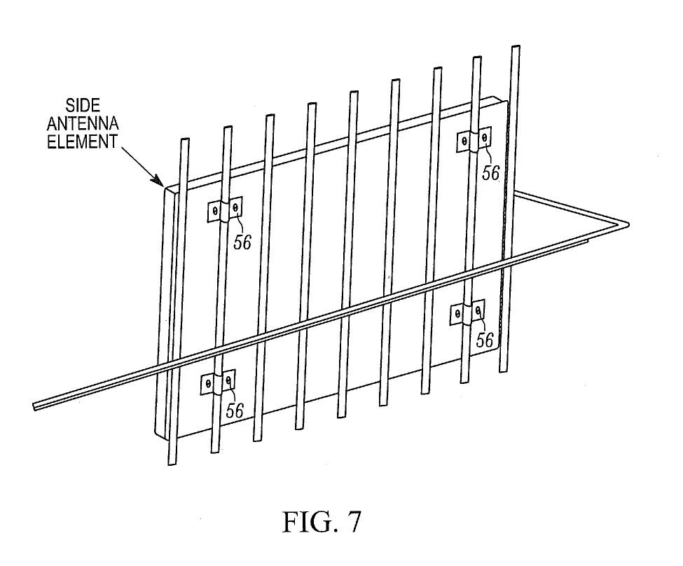

As also shown in FIGS. 1-2, a bidirectional, near-field, bottom antenna element 34 is mounted on, and has a ground plane electrically grounded to, the bottom wall 26, and is operative for radiating both an electromagnetic field in an upward direction toward the interior or center of the basket 20, and another electromagnetic field in a downward direction past the bottom wall 26 toward the lower shelf 22. Details of the bottom antenna element 34 are described below in connection with FIG. 6.

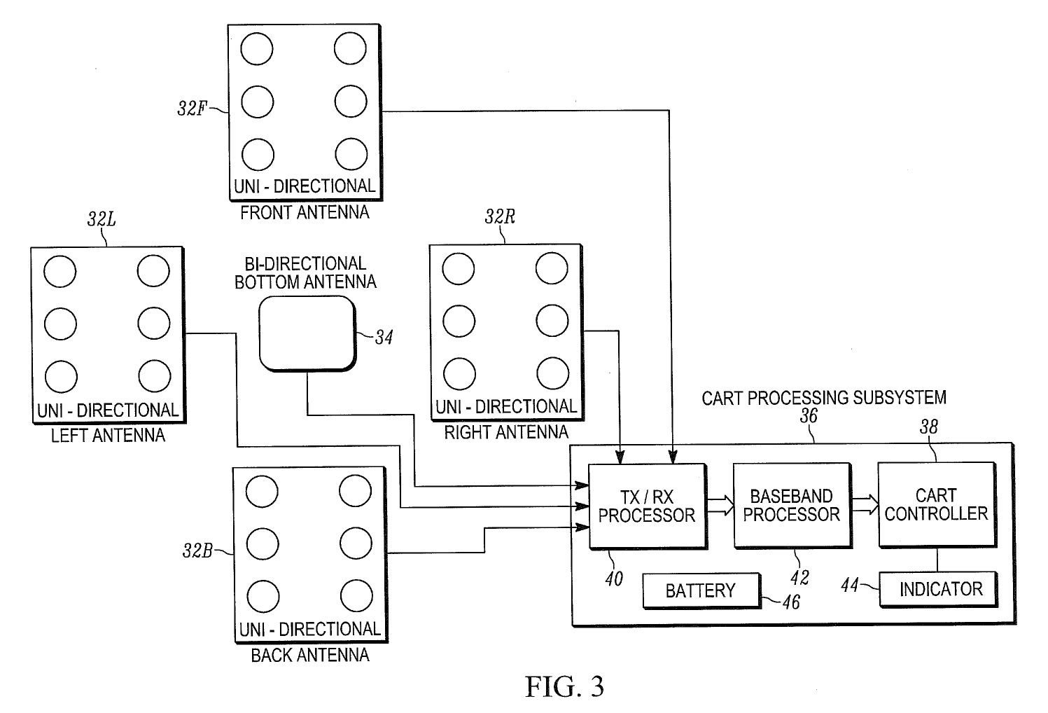

A cart processing subsystem 36 is mounted on the cart, and preferably on the handle 16. The cart processing subsystem 36 includes a cart controller 38 (see FIG. 3), a transmit/receive processor 40, and a baseband processor 42 together operative for exciting all the antenna elements 32R, 32L, 32F, 32B, and 34 to create a composite, resonant electromagnetic field (see FIG. 2) substantially within the basket 20 with substantially no electromagnetic field leakage exteriorly past the side walls 24R, 24L, 24F, and 24B or 28, and for detecting entry and exit of any RFID-tagged item through the open top 18 of the basket 20 into and out of the resonant electromagnetic field, as well as for detecting placement and removal of any RFID-tagged item on and from the lower shelf 22. Preferably, the resonant electromagnetic field is tuned to an RFID frequency on the order of 900 MHz.

As shown in FIG. 3, all the antenna elements 32R, 32L, 32F, 32B, and 34 are wired to the cart processing subsystem 36. These antenna elements could also be in wireless communication with the cart processing subsystem 36. The cart processing subsystem 36 preferably excites all the antenna elements 32R, 32L, 32F, 32B, and 34 simultaneously, but they can also be excited sequentially, for example, at a frequency rate of about 600 milliseconds apart. An indicator 44, e.g., an auditory beeper or a light, on the cart processing subsystem 36 indicates the entry and exit of any RFID-tagged item through the open top 18 of the basket 20, and/or the placement and removal of any RFID-tagged item on and from the lower shelf 22. A battery 46 supplies electrical power to the cart processing subsystem 36. Each antenna element can be provided with its own battery.

As also shown in FIG. 1, a host processing subsystem 48 is mounted remotely from the cart 10. For example, the host processing subsystem 48 can be mounted overhead in a retail store venue, and/or can be mounted at floor level. The host processing subsystem 48 is in wireless communication with the cart processing subsystem 36 and includes an RF communications interface 54, a host server 50, and a product information database 52.

Turning now to FIGS. 4-5, each side antenna element includes, in a preferred embodiment, six microstrip circular patch antennas arranged in a 2×3 array in which the electromagnetic field distribution in the near field, e.g., about 2 wavelengths at 900 MHz (about 26 inches) is enhanced. Thus, the electromagnetic field distribution of each antenna array will substantially extend over the inner volume of a standard shopping cart. Each antenna array has a good near-field focusing property and can read RFID tags with capacitive coupling. In FIG. 6, the bidirectional, bottom antenna element 34 includes, in a preferred embodiment, a top-layer driven dipole 60 for radiating an electromagnetic field upwardly into the basket 20, and a bottom-layer driven dipole 62 for radiating an electromagnetic field downwardly toward the shelf 22. The dipoles 60, 62 are connected to a port 64.

FIG. 7 depicts how any one of the antenna elements is mounted on, and electrically grounded to, the side or bottom walls of the basket 20. A plurality of electrically conductive mounting clips 56 electromechanically connects the ground plane of the antenna to the respective wall of the basket 20.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs), and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A system for detecting items identified by radio frequency identification (RFID) tags, comprising:
a shopping cart including a basket having an open top, the basket having a plurality of electrically conductive side walls and an electrically conductive bottom wall;
a plurality of unidirectional, near-field, side antenna elements mounted on, and electrically grounded to, the side walls, each side antenna element being operative for radiating an electromagnetic field in an inward direction toward an interior of the basket;
a near-field, bottom antenna element mounted on, and electrically grounded to, the bottom wall, and operative for radiating an electromagnetic field in an upward direction toward the interior of the basket; and
a cart controller supported by the cart, for exciting all the antenna elements to create a composite, resonant electromagnetic field substantially within the basket with substantially no electromagnetic field leakage exteriorly past the side walls, and for detecting entry and exit of each RFID-tagged item through the open top of the basket into and out of the resonant electromagnetic field.

2. The system of claim 1, wherein the cart includes a mobile chassis for supporting the basket above a lower shelf; and wherein the bottom antenna element is bidirectional, and also radiates an electromagnetic field in a downward direction toward the lower shelf; and wherein the cart controller is also operative for detecting placement and removal of each RFID-tagged item on and from the lower shelf.

3. The system of claim 1, wherein each side wall and the bottom wall are comprised of a grid of electrically conductive, spaced-apart rods that cross each other.

4. The system of claim 1, wherein each side antenna element has a ground plane that is electrically grounded to a respective side wall to contain the resonant electromagnetic field substantially within the basket.

5. The system of claim 1, wherein the side walls include a right side wall, a left side wall opposite to the right side wall, a front side wall extending between the right and left side walls at a front of the cart, and a back side wall extending between the right and left side walls at a back of the cart; and wherein the side antenna elements are mounted on at least two of the right, left, front, and back, side walls.

6. The system of claim 1, and a cart processing subsystem mounted on the cart and supporting the cart controller, and wherein the cart processing subsystem includes a transmit/receive processor for exciting the antenna elements.

7. The system of claim 6, and a host processing subsystem mounted remotely from the cart processing subsystem, and being in wireless communication with the cart processing subsystem.

8. The system of claim 6, wherein the cart processing subsystem includes an indicator for indicating the entry and exit of each RFID-tagged item through the open top of the basket.

9. The system of claim 6, wherein the resonant electromagnetic field is tuned to an RFID frequency on the order of 900 MHz.

10. The system of claim 1, wherein the antenna elements are excited simultaneously.

11. A method of detecting items identified by radio frequency identification (RFID) tags, comprising:
configuring a shopping cart with a basket having an open top, and with a plurality of electrically conductive side walls and an electrically conductive bottom wall;
mounting a plurality of unidirectional, near-field, side antenna elements on, and electrically grounding the side antenna elements to, the side walls;
mounting a near-field, bottom antenna element on, and electrically grounding the bottom antenna element to, the bottom wall;
exciting each side antenna element to radiate an electromagnetic field in an inward direction toward an interior of the basket;
exciting the bottom antenna element to radiate an electromagnetic field in an upward direction toward the interior of the basket;
the exciting of all the antenna elements creating a composite, resonant electromagnetic field substantially within the basket with substantially no electromagnetic field leakage exteriorly past the side walls; and
detecting entry and exit of each RFID-tagged item through the open top of the basket into and out of the resonant electromagnetic field.

12. The method of claim 11, and supporting the basket above a lower shelf; and configuring the bottom antenna element to be bidirectional such that the bottom antenna element also radiates an electromagnetic field in a downward direction toward the lower shelf; and detecting placement and removal of each RFID-tagged item on and from the lower shelf

13. The method of claim 11, and configuring each side wall and the bottom wall to be comprised of a grid of electrically conductive, spaced-apart rods that cross each other.

14. The method of claim 11, and configuring each side antenna element with a ground plane that is electrically grounded to a respective side wall to contain the resonant electromagnetic field substantially within the basket.

15. The method of claim 11, and configuring the side walls to include a right side wall, a left side wall opposite to the right side wall, a front side wall extending between the right and left side walls at a front of the cart, and a back side wall extending between the right and left side walls at a back of the cart; and mounting the side antenna elements on at least two of the right, left, front, and back, side walls.

16. The method of claim 11, and supporting a cart controller on the cart, and wherein the exciting of the antenna elements is performed with a transmit/receive processor.

17. The method of claim 16, and mounting a host processing subsystem remotely from the cart controller.

18. The method of claim 16, and indicating the entry and exit of each RFID-tagged item through the open top of the basket.

19. The method of claim 16, and tuning the resonant electromagnetic field to an RFID frequency on the order of 900 MHz.

20. The method of claim 11, wherein the exciting of the antenna elements is performed simultaneously.
